(19) United States
(12) Patent Application Publication
(10) Pub. No.: US 2008/0307764 A1
(43) Pub. Date: Dec. 18, 2008

(54) MOBILE HARVESTER

(75) Inventors: Willard Norman Johnson, Mt. Angel, OR (US); Daniel Frederick Setniker, Stayton, OR (US); Frank Steven Brown, Stayton, OR (US)

Correspondence Address: KOLISCH HARTWELL, P.C., 200 PACIFIC BUILDING, 520 SW YAMHILL STREET, PORTLAND, OR, 97204, US

(73) Assignee: LITTAU HARVESTER, INC., Stayton, OR (US)

(21) Appl. No.: 11/762,684

(22) Filed: Jun. 13, 2007

(51) Int. Cl. A01D 46/26; A01D 46/00

(52) U.S. Cl. 56/329

(57) ABSTRACT

Systems, including apparatus and methods, for harvesting a product with a mobile harvester so as to minimize the amount of product lost during harvesting. The disclosed systems include an array of catcher plates designed to surround a plant to be harvested, in a manner that minimizes the possibility of harvested product dropping through the plates to the ground and thus being lost. These systems may be useful for harvesting a wide variety of products that grow on plants such as trees or bushes, including without limitation berries, fruit, and coffee beans.

Fruit, berries, coffee beans, and other similar products may be harvested from their respective plants by hand. However, manual harvesting is time consuming and labor intensive, and often results in a significant amount of lost product, typically in the form of unharvested product that is overlooked or that is too difficult to reach by hand, and thus is never picked from the plant. To overcome these problems, mobile harvesting machines, or simply mobile harvesters, have been developed.

Mobile harvesters may be used to harvest product from plants such as fruit trees, berry bushes, and coffee plants, among others. The harvester generally is driven or otherwise moved along a row of plants, to harvest product from each plant in series. Once in position, straddling or otherwise in the immediate vicinity of a particular plant, the harvester vibrates, shakes, or otherwise disturbs the plant, so that product falls from the plant toward the ground. The harvester then collects the displaced product before it hits the ground, and stores the product for further processing. In some cases, the harvester itself may perform additional processing operations on the collected product, such as cleaning, sorting, or the like.

One potential drawback of mobile harvesters is the difficulty of catching the falling product before it hits the ground. To accomplish this, a harvester may employ an assembly of catcher plates disposed in a central product gathering array of region of the harvester during a harvesting operation. The plates are configured to surround the stem, trunk, roots, branches, or other lower portions of the plant being harvested, without damaging the plant and while leaving as few apertures as possible around the plant for displaced product to fall through. Configuring the plates in a manner that optimally achieves these goals is an area of ongoing research and innovation.

The catcher plates of a harvester typically are rotatable and spring biased toward the central product gathering region of the harvester, and optimally are disposed closely adjacent to the ground. This general configuration is an effective way to accommodate the plant and to catch the falling product, without leaving significant open space in and around the array through which product potentially may pass and be lost. Further, the catcher plates typically are oriented at an angle, sloping downward and outwardly from the center of the product gathering region, so that product falling on the plates will naturally move laterally outward toward the edges of the plates under the influence of gravity. This allows the gathered product to be progressively stored for optional further processing. A system with these general features is disclosed, for example, in U.S. Pat. No. 5,341,630 to Littau, which is hereby incorporated by reference for all purposes.

Although harvesters of the type described above have proven remarkably effective at gathering product, none have yet approached the ultimate goal of zero, or close to zero lost product. For example, depending on the type of product, loss rates of 10%-20% are common using existing harvesters, primarily due to product falling through the catcher plate array to the ground. Therefore, a need exists for an improved harvester having a more effective catcher plate array, and a correspondingly lower loss rate.

### SUMMARY

The present disclosure provides systems, including apparatus and methods, for harvesting a product with a mobile harvester while minimizing the amount of product lost during harvesting. The disclosed systems include an array of catcher plates designed to surround a plant to be harvested, in a manner that minimizes the possibility of harvested product dropping through the plates to the ground and thus being lost. These systems may be useful for harvesting a wide variety of products that grow on plants such as trees or bushes, including without limitation fruit, berries, and coffee beans.

### BRIEF DESCRIPTION OF THE DRAWINGS

FIG. 1 is a simplified side elevational view of a traveling harvester, according to aspects of the present disclosure.

FIG. 2 is a rear elevational view of the harvester of FIG. 1.

FIG. 3 is top view of a catcher bar and plate assembly for a traveling harvester, according to aspects of the present disclosure.

FIG. 4 is a magnified view of a portion of the catcher bar and plate assembly of FIG. 3.

FIG. 5 is an isometric view of a catcher pad configured to support one of the catcher plates upon the catcher bar of FIGS. 3 and 4.

FIG. 6 is an elevational view of the catcher pad of FIG. 5, showing the angular orientation of a pivot pin with respect to the catcher pad.

FIG. 7 is an isometric view of the pivot pin of FIG. 6, showing a D-shaped end feature of the pivot pin.

FIG. 8 is a side elevational view of the pivot pin of FIG. 7, showing the angular orientation of the D-shaped end feature with respect to the long axis of the pivot pin.

FIG. 9 is an isometric view of a portion of the catcher bar and plate assembly of FIGS. 3 and 4, illustrating how a pair of apertures of the catcher bar engages a catcher pad.

### DETAILED DESCRIPTION

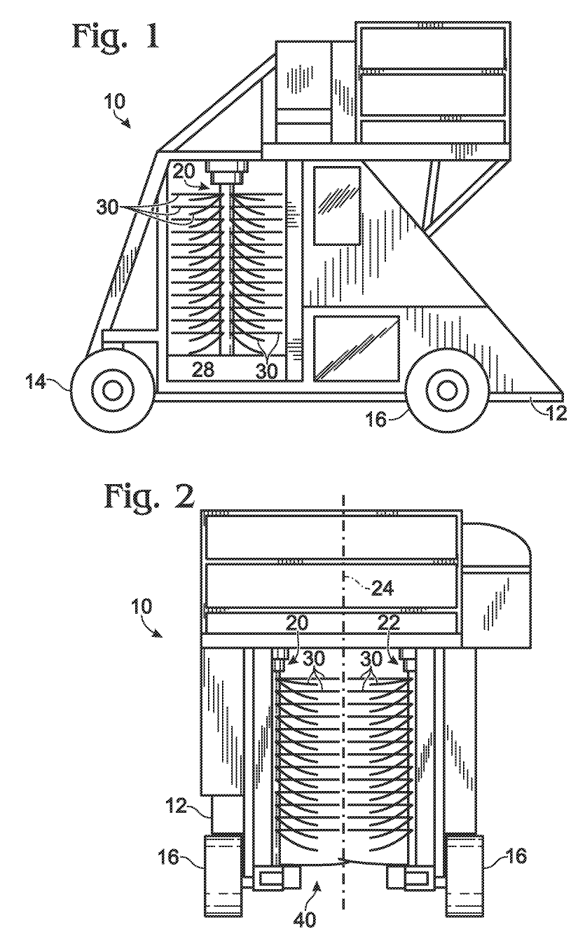

A harvester incorporating a catcher plate array is generally indicated at 10 in FIGS. 1 and 2. The harvester includes a mobile frame 12, which is supported for movement over the ground by a front wheel 14 and rear powered driving wheels 16. Many different ways of supporting the frame and providing mobility are possible, including a front powered driving wheel, various configurations of three or more wheels driven from the front and/or the rear, and treads, among others.

A harvester may be used to harvest a product by traveling along a row of product-bearing plants, with the harvester's rear wheels 16 straddling the row of plants. Plants for which this use of the harvester may be particularly suitable include, for example, raspberry bushes, blueberry bushes, and coffee plants, although any plant of a size that can be substantially accommodated between the rear wheels of the harvester is suitable. In the embodiment illustrated in FIGS. 1 and 2, forward wheel 14 is disposed to one side of the harvester frame, so that the forward wheel may pass each plant without causing damage to the plant.

Adjacent the forward end of the harvester are a pair of rotatable shakers 20, 22. The harvester typically is driven along the row of plants to be harvested, with the row substantially midway between the sides of the harvester frame and shakers 20, 22. Thus, the center of the row being harvested substantially coincides with the dot-dash line 24 shown in FIG. 2, which defines the center of a product gathering region of the harvester.

Each of shakers 20, 22 includes an elongate upright shaft such as shaft 28. The shaft mounts a plurality of elongate flexible fingers 30 that project outwardly from the shaft, and that move inwardly to penetrate the plant being harvested as the harvester moves along the row. The shakers may be rotated as the harvester moves, to compensate for the movement and to maintain any desired rotational orientation with respect to the plant. In addition to rotation, a shaker may be subjected to various other types of movement, such as oscillatory up-and-down movement, or back-and-forth movement, as is conventionally known to be effective for dislodging product such as fruit or berries from the plant.

After being dislodged, material or product dropping from the plant being harvested drops downward and onto a catcher plate assembly 31 attached to the frame of the harvester and disposed near the base of the vehicle. The remainder of this disclosure primarily relates to the structure and function of an innovative catcher plate assembly and its support system, along with its mode of attachment to the harvester.

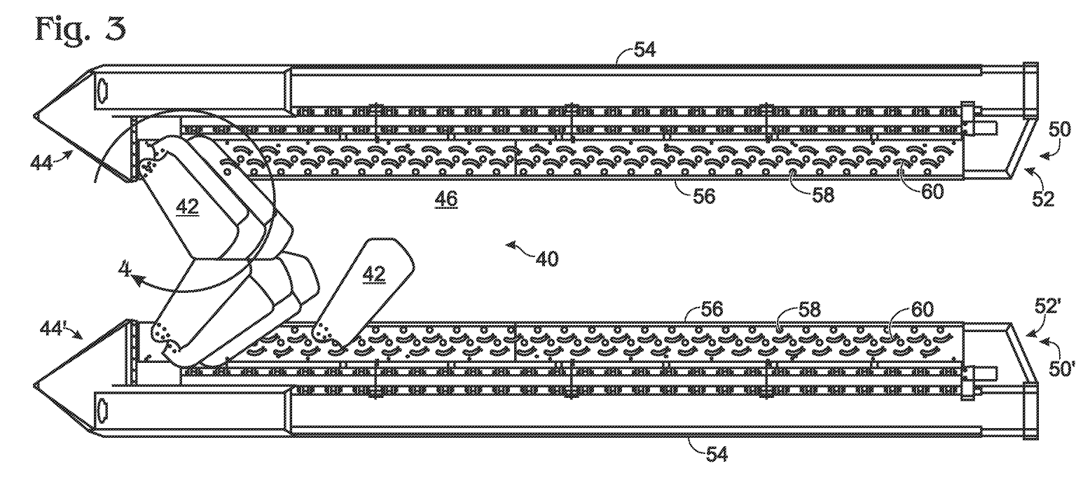

An exemplary catcher plate assembly suitable for use with harvester 10 is generally indicated at 40 in FIG. 3, which shows a top view of the assembly. Catcher plate assembly 40 includes one or more arrays of catcher plates 42, which also may be referred to as plate members, or simply as members. In the embodiment of FIG. 3, plates 42 are arranged in two substantially parallel arrays 44, 44′, which are separated by a central product gathering region 46. The catcher plates are pivotally mounted on a frame portion 48 of the harvester, which is configured to receive the plates in a manner that minimizes the gaps between plates during operation of the harvester, while allowing a desired range of rotation of the plates.

Each of arrays 44, 44′ includes an outer row 50, 50′ of plate members and an inner row 52, 52′ of plate members, as indicated by the mounting positions of the various plates in each array. These rows are generally aligned with a long axis or longitudinal direction along the harvester. Each outer row is disposed adjacent to the corresponding inner row, with the plate mounting positions arranged in a staggered formation. Thus, each plate of an outer row is mounted adjacent to a plate of the corresponding inner row, and furthermore, each plate is generally disposed adjacent to and partially overlapping at least one member of the corresponding inner row.

The staggered arrangement of catcher plates described above permits the plates of each array 44, 44′ to be mounted in relatively close proximity to each other, resulting in a commensurately dense pattern of plates within the array. For example, consecutive members of outer row 50 may be separated by a longitudinal distance of 4-6 inches, and similarly for consecutive members of inner row 52. Assuming that all of the members of an array are equally spaced along the long axis of the harvester, adjacent members of array 44 will be separated by only half the distance between consecutive member of a given row, or only 2-3 inches in the described embodiment. Thus, the staggered arrangement of plates within an array allows the plates to be mounted with a longitudinal density of up to twice the longitudinal density of systems having plates arranged in only a single row.

In addition, the arrays themselves may be staggered with respect to each other. For example, in the embodiment of FIG. 3, plate members of array 44 are staggered with respect to the plate members of array 44′. More specifically, the plate members of outer row 50 are offset longitudinally with respect to the plate members of outer row 50′, and the plate members of inner row 52 are offset longitudinally with respect to the plate members of inner row 52′. In the depicted embodiment, the result of this offset is that the plate members of outer row 50 are approximately longitudinally aligned with the plate members of inner row 52′, and the plate members of inner row 52 are approximately longitudinally aligned with the plate members of outer row 50′, although as described below, this alignment is not necessary.

In general, arrays 44, 44′ may be offset from each other by an amount different from the longitudinal distance between adjacent plates within an array, in which case the plates of one array may not be longitudinally aligned with any of the plate members of the other array. For example, the arrays may be staggered so that each plate of one array is disposed at a longitudinal position that is halfway between the longitudinal positions of the plates of the other array. In the previously described embodiment where consecutive plates of each row are separated by a longitudinal distance of 4-6 inches, this would result in each plate of one array being longitudinally separated from a plate of the other array by 1-1.5 inches. The additional staggering of arrays 44, 44′ may result in more efficient overall coverage of the product gathering region by the assembly.

Frame portion 48 of the harvester includes two parallel sections 54, each of which includes an elongate supporting catcher bar 56 for mounting one of the arrays of catcher plates. As Indicated in FIG. 3, each catcher bar 56 includes a plurality of mounting apertures, including both substantially circular apertures 58, and arcuate apertures or slots 60. These apertures are arranged in pairs consisting of one each of apertures 58 and 60, with each pair configured to mount a catcher plate in a manner described below in more detail.

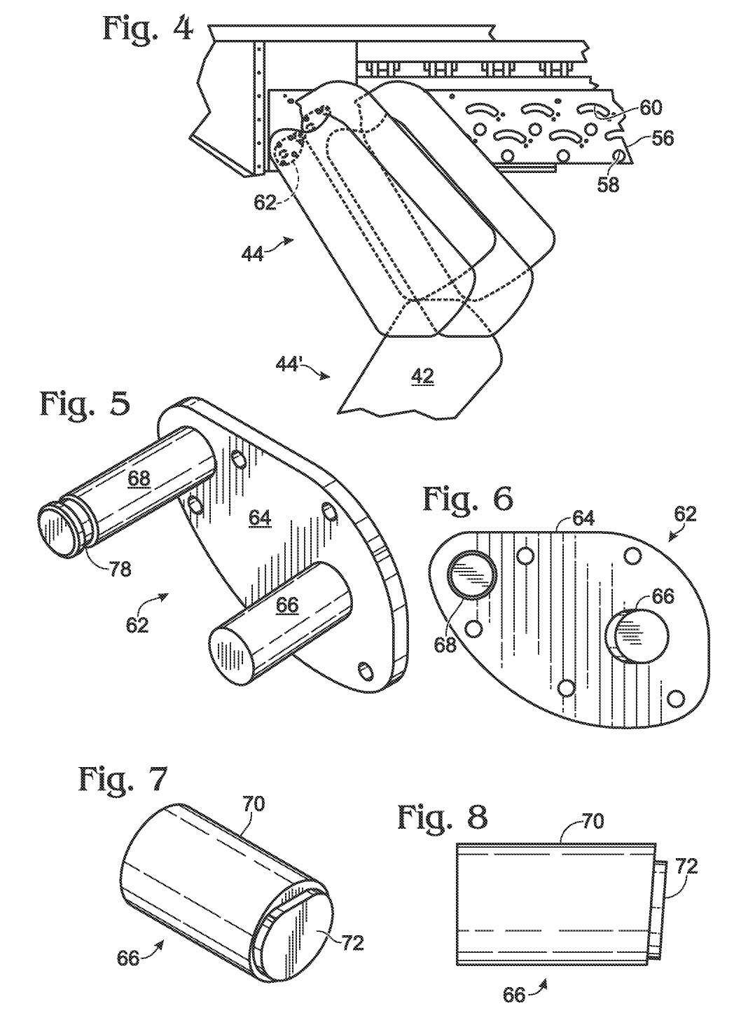

As depicted in FIG. 3 and also in FIG. 4, which shows a magnified view of a portion of FIG. 3, the aperture pairs within each catcher bar are arranged in outer and inner rows, to allow mounting of plates 42 in outer and inner rows within each array 44, 44′. In general, the positions of the aperture pairs will mirror the positions of the catcher plates, including any staggering and/or longitudinal separation. Because the staggered and offset arrangement of the rows of plates has already been described above in detail, and because the arrangement of aperture pairs shown in FIGS. 3 and 4 corresponds to the described plate arrangement, the precise arrangement of the aperture pairs will not be described further.

As can be seen in FIG. 4, each catcher plate 42 is mounted to a corresponding pair of apertures using a catcher pad 62, aspects of which are shown, and will be further described below, with reference to FIGS. 5-8. Generally, each catcher plate 42 is attached to and supported by one of catcher pads 62. The plate may be attached to the pad by, for example, welding, adhesive, or any other suitable means. The pad in turn engages and is supported by the corresponding catcher bar 56 through a pair of apertures, including one circular aperture 58 and one arcuate slot 60. As described below, each circular aperture 58 is configured to rotatably anchor a catcher pad, and each arcuate slot 60 is configured to allow limited rotation of the catcher pad.

FIG. 5 shows an isometric view of one of catcher pads 62. The pad includes a substantially planar body portion 64, a pivot pin 66, and a stop pin 68 (also referred to as a spring pin). Pivot pin 66 is configured to pass through one of apertures 58, and stop pin 68 is configured to pass through one of arcuate slots 60, thus engaging pad 62 with a pair of apertures in the catcher bar. The pivot pin and the stop pin may, for example, be integrally molded with the body of the pad, or they may be manufactured separately and attached to the pad body through welding, adhesive, or any other suitable means. As indicated in FIG. 6, which is an elevational view of pad 62 shown in FIG. 5, the stop pin 68 may be aligned substantially perpendicular to body portion 64 of the pad, whereas the pivot pin 66 may be aligned at a small angle relative to the perpendicular direction.

FIGS. 7-8 show details of pivot pin 66, illustrating how it may be attached to body portion 64 of a catcher pad at a desired angle. As shown in FIG. 7, which is an isometric view of a pivot pin, the depicted pin embodiment includes a substantially cylindrical body 70, and a D-shaped protrusion 72 disposed at one end of the body. D-shaped protrusion 72 is configured to fit into a complementary D-shaped receptacle (not shown) in body portion 64 of the pad, which locks the pivot pin into alignment with the body portion. Furthermore, as indicated in the side elevational view of the pivot pin shown in FIG. 8, D-shaped protrusion 72 may be formed at a slight angle, for example 2-4 degrees, to body 70 of the pin. This results in the previously described angular orientation of the pivot pin relative to body portion 64 of the catcher pad.

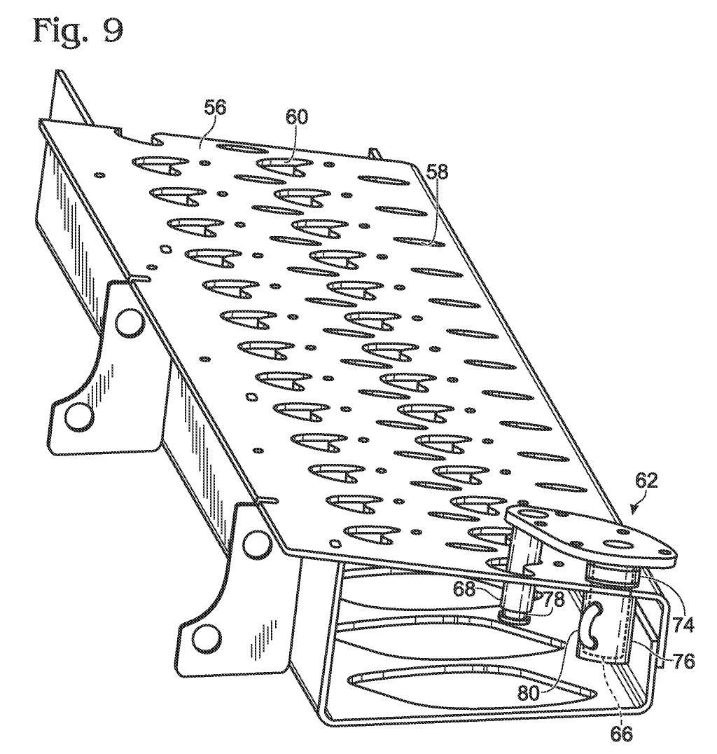

FIG. 9 is an isometric view of a portion of one of catcher bars 56 with a single catcher pad 62 attached to the bar. As described previously, pivot pin 66 is configured to pass through one of apertures 58, and stop pin 68 is configured to pass through one of arcuate slots 60. However, as shown in the embodiment depicted in FIG. 9, the pivot pin may be surrounded by additional structure before passing through aperture 58. For example, pin 66 may fit within a cylindrical bushing 74, which in turn fits within a socket 76 before passing through aperture 58. This structure may serve to stabilize the pivot pin within the aperture, and also may facilitate spring-biasing of the catcher pads, as will be described below.

Still referring to FIG. 9 and also as can be seen in FIG. 5, stop pin 68 includes an indention 78, which is substantially cylindrical in the depicted embodiment. Indentation 78 may, for example, be formed integrally with the remainder of the stop pin, or alternatively, the stop pin may be formed of two separate parts that join together to form the indentation. In the latter case, the two parts of the stop pin may be joined rotatably (e.g., by complementary threading), or they may be joined by friction, adhesive, welding, or any other suitable means. In any case, indentation 78 is configured to receive one end of a spring (not shown) that may be used to bias the catcher pads, and thus the catcher plates, toward a desired position, typically in the central product gathering region.

As FIG. 9 also shows, the depicted socket 76 includes a retainer or hook 80, which also is configured to receive one end of a spring. Thus, a spring may be attached at one end to an indentation 78 or other portion of a spring pin 68, and at another end to a hook 80 of a catcher socket 76 enclosing a pivot pin. This causes a torque about the axis of rotation of the pivot pin, and thus biases the stop pin toward one end of its corresponding arcuate slot 60.

Depending on the desired amount of torque, springs of various types (i.e. spring constants) may be used. In this manner, various amounts of spring biasing may be attained. This allows a catcher bar assembly to be reconfigured for harvesting various different types of product, which may be desirable due to varying degrees of strength of different types of plants. For instance, less spring biasing may be appropriate for harvesting a relatively delicate plant as compared to a relatively sturdy and robust plant.

Socket 76 may be configured to pass through its respective aperture 58 in the catcher bar at a small angle relative to the bar and/or relative to a plane defined by the product gathering region. This angle may, for example, lie in the range of from 2-5 degrees. The angle of the socket relative to the plane of the product gathering region, in combination with the previously described angle with which the pivot pin 66 of each catcher pad meets body portion 64 of the pad, together form a compound angle between the catcher pad and the product gathering region in the depicted embodiment.

As a result of the angle between each catcher pad and the product gathering region, the catcher plates may be oriented sloping downward and outwardly from the center of the product gathering region. For example, the catcher pads may be configured to support the plate members at an angle of between 3 degrees and 8 degrees relative to the plane of the product gathering region. Thus, product falling on the plates from above will naturally move laterally outward toward the edges of the plates under the influence of gravity. This allows the gathered product to be conveniently collected and stored.

In operation, a harvester of the type just described is first positioned around a plant such as a berry bush, with the base of the bush located within a central berry gathering region of the harvester. Typically, the harvester will be positioned by an operator who drives the machine into position, although automated positioning or remote controlled operation also may be appropriate for some applications. As the harvester approaches the desired position, the catcher plates of the harvester typically will rotate within the berry gathering region, to accommodate the lower portions of the bush such as its stem, roots, and any particularly low-lying branches or foliage.

Once the harvester is substantially in position, the shakers are used to vibrate the bush, causing berries to drop from the bush toward the ground. Because the spring biasing of the plates, coupled with their overlapping and staggered configuration, leaves relatively few gaps in the product gathering region through which falling berries may pass, the array of catcher plates catches at least a substantial fraction (preferably 90% or more) of the dropped berries. As described previously, the plates typically will be oriented at an angle of between 3-8 degrees relative to the plane of the berry gathering region, so that the berries caught by the array will tend to roll or otherwise move toward the outer edges of the plates. There, a conveyor belt or other transfer mechanism may transfer the berries to a storage area or a processing area. For example, the collected berries may be transferred to a cleaning area of the harvester, where a blower and/or a washer may be used to clean the berries and to remove dirt, twigs, and so forth from the collected material. Additional processing stations also may be provided within the harvester, for example to sort or package the collected product.

1-9. (canceled)

10. A harvester system, comprising:
a catcher plate array for collecting harvested product, the array including a plurality of pivotable plate members arranged in at least a first outer row of plate members and a first inner row of plate members;
a plurality of catcher pads for supporting the plate members; and
a traveling frame including a catcher bar assembly for pivotally mounting the catcher pads and the plate members.

11. The harvester system of claim 10, wherein the plate members of the first outer row and the plate members of the first inner row are disposed in alternating fashion, with each member of the first outer row adjacent to and partially overlapping at least one member of the first inner row.

12. The harvester system of claim 10, wherein the catcher bar assembly includes first and second elongate support structures separated by a product gathering region, wherein the first outer row of plate members and first inner row of plate members are pivotally mounted on the first elongate support structure, and wherein a second outer row and a second inner row of plate members are pivotally mounted on the second elongate support structure.

13. The harvester system of claim 10, wherein the catcher bar assembly includes a first elongate support structure having a plurality of aperture pairs, each aperture pair configured to engage a corresponding one of the catcher pads.

14. The harvester system of claim 13, wherein each aperture pair includes a first substantially circular aperture for engaging a pivot pin of the corresponding catcher pad, and a second substantially arcuate aperture for engaging a stop pin of the corresponding catcher pad.

15. The harvester system of claim 10, wherein the catcher pads are configured to support the plate members at an angle of between 3 degrees and 8 degrees relative to a plane defined by a central product gathering region of the frame.

16-20. (canceled)

21. A harvester system, comprising:
a catcher plate array for collecting harvested product, the array including a plurality of pivotable plate members arranged in at least a first outer row of plate members and a first inner row of plate members; and
a traveling frame including a catcher bar assembly for pivotally mounting the plate members;
wherein each member of the first outer row is disposed adjacent to and partially overlapping at least one member of the first inner row.

22. The harvester system of claim 21, wherein the catcher plate array further includes a second outer row of plate members and a second inner row of plate members, and wherein each member of the second outer row is disposed adjacent to and partially overlapping at least one member of the second inner row.

23. The harvester system of claim 22, wherein the plate members of the first outer row are offset longitudinally with respect to the plate members of the second outer row, and the plate members of the first inner row are offset longitudinally with respect to the plate members of the second inner row.

24. The harvester system of claim 21, wherein the catcher bar assembly defines a longitudinal axis, and wherein adjacent plate members are separated by a distance along the longitudinal axis of between 2 inches and 3 inches.

25. The harvester system of claim 21, wherein the catcher bar assembly includes:
a first elongate support structure having a plurality of aperture pairs, including a first outer row of aperture pairs and a first inner row of aperture pairs;
wherein the first outer row of aperture pairs and the first inner row of aperture pairs are offset from each other so that adjacent aperture pairs of the first support structure are disposed in a staggered configuration, with each aperture pair of the first outer row adjacent to at least one aperture pair of the first inner row; and
wherein each aperture pair of the first support structure is configured to engage a catcher pad for supporting one of the plate members.

26. The harvester system of claim 25, wherein the catcher bar assembly further includes:
a second elongate support structure having a plurality of aperture pairs, including a second outer row of aperture pairs and a second inner row of aperture pairs;
wherein the second elongate support structure is disposed substantially across a product gathering region from the first elongate support structure;
wherein the second outer row of aperture pairs and the second inner row of aperture pairs are offset from each other so that adjacent aperture pairs of the second support structure are disposed in a staggered configuration, with each aperture pair of the second outer row adjacent to at least one aperture pair of the second inner row; and
wherein each aperture pair of the second support structure is configured to engage a catcher pad for supporting one of the plate members.

27. The harvester system of claim 25, wherein a first aperture of each aperture pair is configured to rotatably anchor a catcher pad at a pivot point, and a second aperture of each aperture pair is configured to allow limited rotation of the catcher pad about the pivot point.

28. The harvester system of claim 27, wherein the first aperture of each aperture pair is a substantially circular aperture configured to receive a pivot pin of the catcher pad, and wherein the second aperture of each aperture pair is an arcuate slot configured to receive a stop pin of the catcher pad.

29. The harvester system of claim 27, wherein the first aperture of each aperture pair is configured to receive a catcher socket at an angle in the range of 2 degrees to 5 degrees relative to a plane defined by the first aperture.

30. A harvester system, comprising:
a catcher plate array for collecting harvested product, the array including a plurality of pivotable plate members arranged in at least a first outer row of plate members, a first inner row of plate members, a second outer row of plate members, and a second inner row of plate members; and
a traveling frame for pivotally mounting the plate members;
wherein the frame defines a plane, and wherein the frame is configured to support the plate members at an angle of between 3 degrees and 8 degrees relative to the plane defined by the frame.

31. The harvester system of claim 30, wherein each member of the first outer row is disposed adjacent to and partially overlapping at least one member of the first inner row, and wherein each member of the second outer row is disposed adjacent to and partially overlapping at least one member of the second inner row.

32. The harvester system of claim 31, wherein the frame includes a first frame portion for pivotally mounting the first outer row of plate members and the first inner row of plate members, and a second frame portion for pivotally mounting the second outer row of plate members and the second inner row of plate members, and wherein the frame defines a central product gathering region between the first and second frame portions.

33. The harvester system of claim 31, wherein the plate members of the first outer row are offset longitudinally with respect to the plate members of the second outer row, and the plate members of the first inner row are offset longitudinally with respect to the plate members of the second inner row.

34. The harvester system of claim 31, wherein the frame defines a longitudinal direction, wherein consecutive plate members of each row are separated from each other by a longitudinal distance of 4-6 inches, and wherein adjacent plate members of the array are separated from each other by a longitudinal distance of 2-3 inches.
